(19) United States
(12) Patent Application Publication
(10) Pub. No.: US 2012/0134903 A1
(43) Pub. Date: May 31, 2012

(54) Solid Inorganic Composition, Method for Preparing Same, and Use Thereof for Reducing Dioxins and Heavy Metals in Flue Gas

(76) Inventors: Alain Brasseur, Grace-Hollogne (BE); Jean-Paul Pirard, Liege (Chenee) (BE); Alain Laudet, Namur (BE)

(21) Appl. No.: 13/383,347

(22) PCT Filed: Jul. 13, 2010
(86) PCT No.: PCT/EP2010/060075

§ 371 Date: Feb. 14, 2012

Related U.S. Application Data
(60) Provisional application No. 61/332,254, filed on May 7, 2010.

(30) Foreign Application Priority Data
Jul. 13, 2009 (BE) 2009/0427

(51) Int. Cl. B01D 53/64; B01D 53/02; B01J 20/30; B01D 53/72; B01J 20/10; B01J 20/28

(52) U.S. Cl. 423/210; 502/410; 95/134

(57) ABSTRACT

The invention relates to a solid inorganic composition for reducing dioxins and furans, as well as heavy metals, in particular mercury, present in flue gases, to a method for preparing such a composition, and to the use thereof for reducing dioxins and furans as well as heavy metals, in particular mercury, present in flue gases, by contacting said flue gases with said solid inorganic composition.

The present invention relates to a composition for reducing heavy metals and dioxins in flue gases comprising a solid absorption material which is a minimal compound, preferably non-functionalized, selected from phylosilicates of the “palygorskite-sepiolite” group, according to the Dana classification.

Dioxins and furans as well as heavy metals, notably mercury, are toxic compounds present in flue gases, notably in the gas state and the emission of which is generally strictly regulated. In the sense of the invention, the term of “dioxin” will be used in the generic sense, including dioxins as well as furans and possibly other analog compounds, notably precursors of dioxins and furans such as polycyclic aromatic hydrocarbons (PAH). Indeed, standards in this regard generally group the whole of the dioxins (75 species) and of the furans (135 species) into a single “toxic equivalent” concentration (TEQ), expressed relatively to the most toxic dioxin molecule.

By the terms of “heavy metals”, are mainly meant metals having a density of more than 5,000 kg/m³, notably the most common heavy metals, generally being subject to regulations, i.e. lead, chromium, copper, manganese, antimony, arsenic, cobalt, nickel, vanadium cadmium, thallium and mercury, preferably lead, thallium, cadmium and mercury in particular mercury. These metals may appear in the elementary state or in ionic form.

The reduction of dioxins and heavy metals present in flue gases is generally performed in the state of the art by means of carbonaceous compounds, such as active coals, lignite cokes or the like. The selection of the type(s) of carbonaceous compounds depends on the predominance of dioxins on the one hand or of heavy metals on the other hand, in pollutants to be reduced and on respective regulations to be met for both of these types of pollutants.

For example, document WO 2006/099291 discloses the reduction of mercury of flue gases by using a catalytic adsorbent in the form of a carbonaceous compound doped with halogenated compounds. More particularly, a halide salt is dispersed on active coal and the catalytic oxidation activity of the active coal promotes the formation of a mercury halide. An oxidant oxidizes the mercury and the anion of the doping compound provides a counter-ion for the mercury ion oxidized by the oxidant. As this is observed, the presence of an oxidant is therefore essential in this type of compound.

In many situations, in particular in the case of waste incineration units, the initial emissions of dioxins and certain heavy metals exceed, some times by far, that of the regulations in effect, so that it is absolutely necessary to reduce, sometimes considerably, both of these types of pollutants. A same well-selected carbonaceous compound may then be suitable for simultaneously observing the regulations in effect for heavy metal discharges and those relating to discharges of dioxins. It may be applied either as such, or as a mixture with a basic reagent, in a fixed bed in granular form or by injection into the gas in a powdery form; the solid particles are then trapped downstream, for example in a textile filter, where their action is prolonged.

The efficiency of carbonaceous compounds for reducing heavy metals and dioxins is unanimously recognized. Nevertheless, the use of these carbonaceous compounds in flue gases has two major drawbacks:
the increase in the total organic carbon content in the dusts present at the discharge of these fumes, a carbon content which is strictly regulated;
the risk of flammability, all the greater since the temperature of the gases to be purified is high.

An improvement provided by one skilled in the art for solving the problems of ignition of carbonaceous compounds was to use them in a mixture with uninflammable substances, such as lime. Unfortunately, this improvement actually reduced the risks of ignition of the carbonaceous compounds but did not completely suppress them. Indeed, hot spots may further appear, even at low temperature (for example 150° C.), notably in the presence of infiltration of air in areas where the carbonaceous compounds are subject to accumulation.

Carbonaceous compounds are generally costly compounds and the step applying said carbonaceous compounds is difficult to integrate into a complete method for treating flue gases, which often has to also remove nitrogen-containing pollutants. Removal of nitrogen oxides via a catalytic route is generally practiced at a gas temperature above 200° C., not compatible with the use of carbonaceous compounds. For good compatibility with a step of the method using carbonaceous compounds, the cooling of the flue gases and the heating of the latter has to be alternated. This represents a significant energy loss and overcost. It is therefore difficult to integrate carbonaceous compounds into a method for treating fumes, given the ignition problems caused by these compounds.

Documents “ES 8704428” or “ES 2136496”, and “GIL, ISABEL GUIJARRO; ECHEVERRIA, SAGRARIO MENDIOROZ; MARTIN-LAZARO, PEDRO JUAN BERMEJO; ANDRES, VICENTA MUNOZ, Mercury removal from gaseous streams. Effects of adsorbent geometry, Revista de la Real Academia de Ciencias Exactas, Fisicas y Naturales (Spain) (1996), 90 (3), pp, 197-204” mentioned that it is possible to do without carbon for reducing heavy metals, in particular mercury, by using sulfur as a reagent. The sulfur is deposited on a mineral support, such as natural silicates. Such formulations thus overcome the aforementioned drawbacks of carbonaceous compounds. In this case, the silicate is considered as an inert support relatively to the pollutant to be reduced; the latter is trapped by reaction with the sulfur-containing compound so as to generally form a sulfide.

Unfortunately, silicates functionalized by sulfur-containing compounds are subject to dangerous, burdensome and costly manufacturing which is a penalty to their use. For example, document ES 8704428 discloses sulfurization of a silicate by an oxidation reaction of hydrogen sulfide at a well defined molar proportion with the purpose of adsorbing elementary sulfur on said silicate. The handling of hydrogen sulfide, which is highly toxic and extremely flammable, is dangerous and the required strict molar proportion for avoiding any subsequent oxidation reaction is very restrictive. Document “ES 2136496” provides a similar teaching, describing a method for sulfurization of natural silicates for retaining metal vapors.

It is noted that substitutes for the carbonaceous compounds described above are limited to the reduction of heavy metals.

Other alternative compositions to the carbonaceous compounds as described at the beginning, are described for reducing dioxins, in particular the use of a mineral of the sepiolite type or the like, which is non-functionalized (see notably JP 2000140627, JP 2001276606 and JP 2003024744). However, all the phylosilicates do not appear to be good sorption solids for dioxins. For example, montmorillonite ‘Japanese Acid Clay’ (JAC), montmorillonite K10 and ‘China Clay’ kaolin capture no or very little chlorobenzene or other model molecules used because of their analogies with dioxins (Chemosphere, 56 8, 745-756 (2004)).

Siliceous adsorbent compositions are also known from document FR 1481646, obtained by reaction notably with hydrochloric acid at a high concentration, intended for adsorption of gases or liquids. In these compositions, the initial compound has reacted so as to be transformed into an amorphous compound which therefore does not retain its initial crystalline structure. This document further discloses compounds obtained as a composite. Moreover, the reduction results mentioned in the examples exclusively relate to liquids such as water or to gases such as oxygen or possibly butane or the like.

Document DE 198 24 237 as for it discloses mineral compounds to which are additives added for capturing mercury. The disclosed additives are generally sulfur-containing compounds, providing with this, a teaching similar to the aforementioned Spanish references. Mention is also made of the use of chlorides which are mineral phyllosilicates from the group of chlorides.

As this is seen, the prior art provides substitutes for carbonaceous compounds for purifying flue gases but the proposed solutions either relate to the reduction of dioxins or to the reduction of heavy metals.

Patent EP 1732668 B1 provides the use of non-functionalized mineral compounds of the “palygorskite-sepiolite” group according to the Dana classification for reduction of heavy metals, in particular mercury. However, the efficiency of sepiolite for reducing mercury seems to be limited, as compared with active coals, a priori requiring overdosage.

The object of the invention is to find a remedy to the drawbacks of the prior art, by providing a composition as mentioned at the beginning in which said mineral compound is doped with a halide salt.

Indeed, it was observed very unexpectedly and in an unpredictable way that this mineral compound doped with a halide as a salt allowed joint and effective reduction of dioxins and of heavy metals, notably in the gas state, present in flue gases, by using a same and single mineral compound, the manufacturing and the application of which are simple and not dangerous.

The effect of this composition according to the invention on the reduction rate of dioxins and of heavy metals is particularly unexpected for the following reasons. Measurements of the BET specific surface area and of the BJH pore volume, directly carried out on the doped mineral compound, show a sometimes significant decrease of these two characteristics, at the very least with a strong dopant salt content. Moreover, it is conceivable that crystallization of a salt on a porous support should modify the accessibility to the pores for molecules of large size such as dioxins. Finally, by covering the surface of a porous solid even partially, with a compound of a different nature, it is possible to modify the adsorption capacity for molecules such as dioxins. These elements suggest a risk of reduction of the performances for reducing the doped mineral compound relatively to the non-doped mineral compound, since it is known that the capacities for reducing dioxins and heavy metals are directly influenced by the aforementioned elements.

In a particular embodiment, the mineral compound is selected from the group of phyllosilicates of the sub-group of sepiolite according to the Dana classification.

The phyllosilicates targeted by the invention have high porosity, typically a pore volume comprised between 0.20 and 0.60 cm³/g, notably between 0.25 and 0.40 cm³/g, measured by the BJH method, applied to the nitrogen desorption isotherm, obtained at the temperature of liquid nitrogen (77 K) This pore volume interval is valid for pores with a size comprised between 2 and 100 nanometres. Moreover, these phylosilicates typically have a specific surface area from 100 to 200 m²/g, particularly from 110 to 160 m²/g.

By “mineral compound doped with a halide salt” is meant an aforementioned mineral compound, for which the surface accessible to flue gases is partly or completely covered with halide salt.

The surface accessible to the gas not only comprises the external surface of the particles making up the mineral compound but also a portion or the whole of the internal surface of these partially porous particles.

The mineral compound doped with a halide salt contains on a dry basis, from 0.5% to 20%, preferably from 1% to 15%, in particular, from 1.5% to 10% by weight of halide salt based on the weight of the composition according to the invention. The halide salt may be an alkaline or earth alkaline halide, notably NaCl, NaBr or Nal, KCl, KBr or Kl, CaCl₂, CaBr₂ or Cal₂, MgCl₂, MgBr₂ or MgI₂, or further NH₄C₁, NH₄Br or NH₄I or one of their mixtures.

In a particular embodiment according to the invention, the mineral compound doped by said halide salt has a BET specific surface area comprised between 70 and 170 m²/g, often between 80 and 140 m²/g and in particular between 90 and 130 m²/g.

Preferably, the mineral compound doped by said halide salt has a pore volume comprised between 0.15 and 0.32 cm³/g, preferably between 0.20 and 0.30 cm³/g and more preferentially between 0.22 and 0.28 cm³/g, as measured by the BJH method, applied to the nitrogen desorption isotherm, obtained at a temperature of liquid nitrogen of about 77K for pores with a size comprised between 2 and 100 nm.

Advantageously, the mineral compound according to the invention is in powdery form, i.e. the size of the particles is in majority (more than 90%) smaller than 1 mm and essentially greater than 1 μm, i.e it preferably has a d₉₀ of less than 1 mm.

By d₉₀ is meant the interpolated value of the distribution curve of the particle sizes, such that 90% of the particles have a smaller size than said value.

Unexpectedly, it was possible to show that these mineral compounds, thereby doped with halide salt give the possibility of reducing with great efficiency heavy metals, notably in the gas state, in particular mercury and most particularly mercury metal Hg⁰, in flue gases, while retaining the properties for reducing dioxins which these mineral compounds have in the absence of doping, in particular retaining the initial crystalline structure.

Other embodiments of the product according to the invention are indicated in the appended claims.

The object of the present invention is also a method for preparing a mineral solid composition according to the invention. This method comprises the steps:
supplying a solid sorption material which is a mineral compound, preferably non-functionalized, selected from phyllosilicates of the “palygorskite-sepiolite” group according to the Dana classification,
supplying a halide salt, and
putting into contact said mineral compound and said halide salt with formation of a mineral compound doped with the halide salt.

Advantageously, said putting into contact of said mineral compound and of said halide salt is achieved with stirring.

Preferably, said supplied mineral compound has humidity comprised between 0.1 and 100 g/kg, advantageously between 2 and 90 g/kg.

Advantageously, said putting into contact is carried out at room temperature.

In a preferential embodiment of the method according to the invention, said halide salt is in liquid form, in an aqueous phase.

Further, said step for putting into contact said mineral compound and said halide salt is advantageously spraying of said halide salt on said mineral compound, optionally in the presence of stirring.

In an alternative preferential embodiment of the method according to the invention, said step for putting into contact said compound and said halide salt is a soaking operation in one or several steps, optionally with stirring and optionally with intermediate steps for drying and/or deagglomerating said mineral compound in said halide salt in a liquid phase.

Preferably, said halide salt in a liquid phase is an aqueous solution having a halide salt content comprised between 1% and the saturation of the solution with the salt, notably between 1% and 30%, in particular between 5% and 27%, preferably between 10% and 27% by weight, based on the total weight of said solution. It should be noted that a low salt concentration in the solution leads to a more difficult application of the mixture as well as to more expensive subsequent drying. Moreover, the concentration of the solution is limited by the solubility of the salt. Putting into contact the halide salt and the mineral compound is performed so as to promote a distribution as homogeneous as possible of the halide salt on the external surface but also on the internal accessible surface of the mineral compound.

Advantageously, the method according to the invention further comprises a step for drying and/or deagglomerating said mineral compound doped with the halide salt, preferably according to operating conditions (ambient temperature, dwelling time . . . ) so that the doped mineral compound reaches a temperature comprised between 60 and 200° C., in particular between 75 and 170° C., with view to attaining a residual humidity preferably below 100 g/kg, advantageously below 50 g/kg.

As mentioned earlier, preferably, in the method according to the invention, said halide salt is an alkaline halide, an earth alkaline halide or the like, preferably selected from the group consisting of NaCl, NaBr, Nal, KCl, KBr, KI, CaCl₂, CaBr₂, CaI2, MgCl₂, MgBr₂, MgI₂, NH₄C₁, NH₄Br or NH₄I or mixtures thereof.

Other embodiments of the method according to the invention are indicated in the appended claims.

The present invention further relates to a use of a mineral solid composition as described above for reducing dioxins and heavy metals, notably in the gas state, in particular mercury and most particularly mercury metal Hg⁰, present in flue gases, by putting the flue gases into contact with the aforementioned mineral solid composition and to a use of a mixture of a basic reagent and of said mineral solid composition for treating the flue gases.

The doped mineral compound according to the invention is therefore put into contact with the flue gases to be treated, either as such, either in association with a basic agent currently used for reducing sour gases of fumes, such as lime or the like.

Consequently, the application of the mineral solid composition according to the invention only requires the obtaining of a preferably dry simple-to-use product.

The use of the doped mineral compound according to the invention for reducing dioxins and heavy metals therefore comprises putting into contact of said doped mineral compound, preferably in the dry condition, performed at a temperature comprised in the range from 70 to 350° C., preferably between 110 and 300° C. and more preferentially between 120 and 250° C. The possibility of operating at temperatures close to or above 200° C. gives the possibility of maintaining a relatively constant temperature all along the method for treating flue gases and of avoiding or limiting the consecutive cooling and heating steps for removing dioxins and heavy metals and then that of nitrogen-containing compounds by catalysis.

Advantageously, the mineral compound according to the invention is used in powdery form, i.e. the size of the particles is in majority (more than 90%) less than 1 mm and essentially greater than 1 μm. The mineral compound is then injected via a pneumatic route into the gas vein.

The use of the doped mineral compound according to the invention for reducing dioxins and heavy metals in flue gases is often to be integrated into a complete treatment of flue gases. Such a treatment comprises a step for removing majority acid pollutants by putting said flue gases into contact with basic reagents. Generally, the majority acid pollutants in flue gases comprise hydrochloric, hydrofluoric acids, sulfur oxides or further nitrogen oxides, their contents in the emission of flue gases before treatment are of the order of several tens to several hundred mg/Nm³.

When the use of the doped mineral compound according to the invention for reducing dioxins and heavy metals in flue gases is integrated into a complete treatment of flue gases, said basic reagents, for example, lime, and said doped mineral compound are applied separately or as a mixture. The latter case allows a gain in investment and room since consequently both steps may be carried out simultaneously and in the same location.

Other uses according to the invention are mentioned in the appended claims.

Other features, details and advantages of the invention will become apparent from the description given hereafter, as non-limiting and referring to the examples.

The invention will now be described in more details by means of non-limiting examples.

Examples 1 to 7 and the comparative example are laboratory-scale tests, according to the following experimental procedure. The mineral compound doped with a halide salt (Examples 1 to 5, according to the invention) or a non-doped mineral compound (Comparative Example) are placed in the centre of a cylindrical reactor with a length of 110 mm and an inner diameter of 10 mm so as to form a homogeneous bed on rock wool, which corresponds to about 0.1 g of mineral compound. A nitrogen stream containing 600 μg/Nm³ of mercury metal)(Hg⁰, with a total flow rate of 2.8 10⁻⁶ Nm³/s crosses this bed. With a detector VM-3000 from Mercury Instruments, it is possible to measure the mercury metal level at the outlet of the reactor. Prior to its arrival at the detector, the gas crosses a solution of SnCl₂, so as to convert into mercury metal, the possible fraction of mercury present in ionic form. In this way, the totality of the mercury is measured. With this device, it is possible to evaluate the capacity of mercury reduction by a solid by applying the principle of the breakthrough curve. The reduction capacity is expressed in (μg Hg)/g of solid, Table 1 summarizes the preparation method and the mercury reduction performances for Examples 1 to 5 and the Comparative Example.

### COMPARATIVE EXAMPLE

Commercially available sepiolite of industrial quality is placed in the reactor described above. A breakthrough curve is achieved at a set temperature of 130° C. The mercury reduction capacity of this non-doped sepiolite in the device described earlier is 9 (μg Hg)/g of sepiolite.

### EXAMPLE 1

Soaking of a sepiolite similar to that of the comparative example is achieved according to the invention. This soaking is achieved by immersing the sepiolite in an aqueous solution with a KBr content of 10% by weight, based on the weight of the aqueous solution. The thereby doped humid sepiolite is dried and deagglomerated, at a temperature of 75° C. in an oven, so as to reach a residual humidity of less than 50 g/kg. The amount of KBr deposited on the sepiolite after drying is 10% by weight based on the weight of the composition obtained according to the invention. The mercury reduction capacity of this KBr-doped sepiolite according to the invention in the device described earlier and operating under the same operating conditions as in the Comparative Example, is 255 (μg Hg)/g of doped sepiolite.

### EXAMPLE 2

Spraying of a sepiolite similar to that of the Comparative Example is achieved according to the invention. The spraying is achieved from an aqueous solution with a NaCl content of 27% by weight based on the weight of the aqueous solution. The solution is sprayed on the sepiolite with mechanical stirring, until a humidity of 20% is obtained. The thereby doped humid sepiolite is dried and deagglomerated, at a temperature of 150° C. in an oven, so as to reach a residual humidity of less than 50 g/kg. The amount of NaCl deposited on the sepiolite after drying is 6% expressed by weight based on the weight of the composition. The mercury reduction capacity of this NaCl-doped sepiolite is equal to 48 (μg Hg)/g of doped sepiolite.

### EXAMPLE 3

Example 2 is reproduced but with a solution of 27% by weight of MgCl₂, based on the weight of the aqueous solution. The amount of MgCl₂ deposited on the sepiolite after drying is 5% expressed by weight, based on the weight of the composition. The measured mercury reduction capacity is equal to 190 (μg Hg)/g of doped sepiolite.

### EXAMPLE 4

Example 2 is reproduced but with a solution of 27% by weight of CaBr₂, based on the weight of the aqueous solution. The amount of CaBr₂ deposited on the sepiolite after drying is 6% expressed by weight, based on the weight of the composition. The measured mercury reduction capacity is equal to 343 (μg Hg)/g of doped sepiolite.

### EXAMPLE 5

Example 2 is reproduced but with a solution of 27% by weight of MgBr₂, based on the weight of the aqueous solution. The amount of MgBr₂ deposited on the sepiolite after drying is 7% expressed by weight, based on the weight of the composition. The measured mercury reduction capacity is equal to 1770 (μg Hg)/g of doped sepiolite.

TABLE 1
Summary of the laboratory tests

| | Example | | | | | |
|---|---|---|---|---|---|---|
| | Compar- | | | | | |
| | ative | 1 | 2 | 3 | 4 | 5 |
| Additive | none | KBr | NaCl | MgCl₂ | CaBr₂ | MgBr₂ |
| Initial | — | 10% | 27% | 27% | 27% | 27% |
| solution | | | | | | |
| Doping | — | Soaking | Spray | Spray | Spray | Spray |
| method | | | | | | |
| Humidity | — | 50% | 20% | 20% | 20% | 20% |
| after | | | | | | |
| impreg- | | | | | | |
| nation | | | | | | |
| Drying | — | 75° C. | 150° C. | 150° C. | 150° C. | 150° C. |
| temper- | | | | | | |
| ature | | | | | | |
| Impregnated | — | 10% | 6% | 5% | 6% | 7% |
| additive | | | | | | |
| level | | | | | | |
| Mercury | 9 | 255 | 48 | 190 | 343 | 1770 |
| level | | | | | | |
| (μg Hg/g) | | | | | | |

### EXAMPLE 6

### Influence of the Temperature of the Reactor

Example 4 is reproduced but the amount of CaBr₂ deposited on the sepiolite after drying is 2% expressed by weight based on the weight of the composition. A breakthrough curve is achieved at set temperatures of 130° C., 180° C., 200° C., 250° C. and 300° C. The measured mercury reduction capacity is respectively equal to 208, 426, 582, 750 and 672 (μg Hg)/g of doped sepiolite under the conditions of the test. These results demonstrate the advantageous use of doped compositions according to the invention, notably between 180° C. and 300° C.

### EXAMPLE 7

### Effect of the Concentration of the Doping Solution

Example 2 is repeated by impregnating 4 samples of sepiolite similar to that of the comparative example by spraying with KBr solutions with a concentration respectively having the value of 5%, 10%, 15%, 30% before obtaining a content of deposited additive of respectively 1.2%, 2.3% and 4.6%. The thereby doped sepiolite according to the invention is placed in a reactor held at a set temperature of 130° C. The mercury reduction capacity is respectively 33, 44 and 75 (μg Hg)/g of doped sepiolite under the conditions of the test.

Surprisingly, it is seen that the doping according to the invention does not significantly alter the initial specific area surface and pore volume of the non-doped mineral compound, in the relevant concentration interval and dopant, which suggests that the dioxin reduction performances have been preserved. On the other hand, a significant increase in the mercury reduction is observed for an increasing concentration of halide salt in the doped sepiolite. The results are summarized in Table 2 below.

TABLE 2
Time-dependent change in the specific surface area,
the pore volume and the mercury reduction versus the
doping additive content

| Additive | Specific surface | Pore volume | Mercury reduction |
|---|---|---|---|
| content | area (m²/g) | (cm³/g) | (μg Hg/g) |
| 0 | 136 | 0.26 | 9 |
| 1.2 | 133 | 0.25 | 33 |
| 2.3 | 132 | 0.24 | 44 |
| 4.6 | 130 | 0.23 | 75 |

### EXAMPLE 8

### Industrial Scale

According to the invention, sepiolite similar to that of the comparative example is doped by spraying in an industrial mixer. For this purpose, an aqueous solution with a content of 20% by weight of KBr based on the weight of the aqueous solution is sprayed. The flow rate of doped sepiolite, with 17% humidity, is 200 kg/h. The latter is deagglomerated and dried in a cage mill/dryer, by means of hot gases at about 400-450° C. and a dwelling time such that the gases leave the mill/dryer at about 150° C. A dried sepiolite according to the invention is obtained with 5% by weight of KBr, based on the weight of the composition.

The thereby doped sepiolite is used in a line for treating 7t/h of waste from an incinerator of domestic waste, producing about 43,000 Nm³/h of fumes to be treated. The doped sepiolite is metered by means of a screw and injected pneumatically into the gas current at 150° C. in an amount of 3 kg/h, and then collected in a sleeve filter, notably with the combustion dust.

The mercury concentrations are measured upstream from the point of injection of the doped sepiolite and downstream from the sleeve filter by atomic absorption (MERCEM from Sick-Maihak). The measured concentrations, normalized on dry gases and referred to 11% of oxygen are:
85 μg/Nm³ upstream and
14 μg/Nm³ downstream from the sleeve filter. This result is clearly less than the 50 μg/Nm³ of the regulations in effect and shows a mercury reduction rate of 84%.

At the same time as the measurement of the mercury content, the dioxin content was measured at the chimney, by an approved organization according to the EN 1948 (1997) and ISO 9096 (2003) standards. The obtained value is 0.04 ng TEQ/Nm³ on dry gases and reduced to a concentration of 11% of O₂. This result perfectly observes the regulations for emissions of 0.1 ng TEQ/Nm³ under dry conditions, reduced to 11% of O₂.

### EXAMPLE 9

### Industrial Scale

The same doped sepiolite as in Example 10 is used in a line for treating 7 t/h of waste from a domestic waste incinerator, producing about 43,000 Nm³/h of fumes to be treated. The doped sepiolite is metered by means of a screw and injected pneumatically into the gas stream at 180° C. in an amount of 8 kg/h, and then collected in a sleeve filter, notably with the combustion dusts.

The mercury concentrations were measured downstream from the sleeve filter by atomic absorption (MERCEM from Sick-Maihak). The measured mercury concentrations normalized on dry gases and referred to 11% of oxygen are from 0.1 μg/Nm³ to 0.8 μg/Nm³. These results are clearly less than the 50 μg/Nm³ of the regulations in effect.

The dioxin content was measured at the chimney, by an approved organization, according to the EN 1948 (1997) and ISO 9096 (2003) standards. It is 0.003 ng TEQ/Nm³ on dry gases and reduced to a concentration of 11% of 02 and perfectly observes the emission regulations of 0.1 ng TEQ/Nm³ under dry conditions, reduced to 11% of O₂

It should be understood that the present invention is by no means limited to the embodiments described above and that many modifications may be brought thereto without departing from the scope of the appended claims.

1. A composition for reducing heavy metals and dioxins in flue gases comprising a solid sorption material which is a mineral compound, preferably non-functionalized characterized in that said mineral compound is selected from phyllosilicates of the “palygorskite-sepiolite” group according to the Dana classification, said mineral compound being doped with a halide salt and retaining the initial crystalline structure, said halide salt being present in an amount on a dry basis ranging from 0.5% to 20% by weight on the basis of the weight of the composition.

2. The composition according to claim 1, wherein said mineral compound is selected from the group of phyllosilicates from the subgroup of sepiolite according to the Dana classification.

3. The composition according to claim 2, wherein said halide salt is an alkaline halide, an earth alkaline halide or the like, preferably selected from the group consisting of NaCI, NaBr, Nal, KCI, KBr, Kl, CaCl₂, CaBr2, Cal₂, MgCI₂, MgBr₂, Mgl₂, NH₄CI, NH₄Br or NH₄I or mixtures thereof.

4. The composition according to claim 3, wherein said halide salt is present in an amount on a dry basis ranging from 1% to 15% by weight and in particular from 1.5% to 10% by weight of halide salt on the basis of the weight of the composition.

5. The composition according to claim 1, wherein the mineral compound doped by said halide salt has a BET specific surface area comprised between 70 and 170 m²/g, preferably between 80 and 140 m²/g and more preferentially between 90 and 130 m²/g.

6. The composition according to claim 5, wherein said mineral compound doped by said halide salt has a pore volume comprised between 0.15 and 0.32 cm³/g, preferably between 0.20 and 0.30 cm³/g and more preferentially between 0.22 and 0.28 cm³/g, as measured by the BJH method, applied to the nitrogen desorption isotherm.

7. A method for manufacturing a composition for reducing heavy metals and dioxins comprising the steps:
supplying a solid sorption material which is a mineral compound, preferably non-functionalized, selected from phyllosilicates from the “palygorskite-sepiolite” group according to the Dana classification,
supplying a halide salt, and
putting into contact said mineral compound and said halide salt with formation of a mineral compound doped with the halide salt.

8. The method according to claim 7, wherein said contacting of said mineral compound and of said halide salt is achieved with stirring.

9. The method according to claim 7 wherein said supplied mineral compound has a humidity comprised between 0.1 and 100 g/kg, advantageously between 2 and 90 g/kg.

10. The method according to claim 8, wherein said contacting is carried out at room temperature.

11. The method according to claim 7, wherein said halide salt is in liquid form, in an aqueous phase.

12. The method according to claim 7, wherein said step for putting into contact said mineral compound and said halide salt is spraying of said halide salt on said mineral compound optionally with stirring.

13. The method according to claim 11, wherein said step for putting into contact said mineral compound and said halide salt is soaking of said mineral compound in said halide salt in a liquid phase, optionally with stirring.

14. The method according to claim 11 wherein said halide salt in a liquid phase is an aqueous solution, having a halide salt content comprised between 1% and 30%, in particular between 5% and 27%, preferably between 10% and 27% by weight based on the total weight of said solution.

15. The method according to claim 7, further comprising one or more steps for drying and/or deagglomerating said mineral compound doped with the halide salt, preferably at a temperature comprised between 60 and 200° C., in particular between 75 and 170° C.

16. The method according to claim 7, wherein said halide salt is an alkaline halide, an earth alkaline halide or the like, preferably selected from the group consisting of NaCI, NaBr, Nal, KCI, KBr, Kl, CaCl₂, CaBr2, Cal₂, MgCI₂, MgBr₂, Mgl₂, NH₄CI, NH₄Br or NH₄I or mixtures thereof.

17. The use of the composition according to claim 1, for reducing dioxins and heavy metals, preferably in the gas state, in particular mercury and most particularly mercury Hg⁰ in flue gases.

18. The use according to claim 17, as a mixture with a basic reagent such as lime.
